(19) United States
(12) Patent Application Publication
(10) Pub. No.: US 2009/0245613 A1
(43) Pub. Date: Oct. 1, 2009

(54) Method And System For Producing Digital Electronic Document Security Graphics Files

(76) Inventors: Judy Wailing WU, Markham (CA); Robert A. McTAGGART, Markham (CA); Edward FLORENCE, Toronto (CA); Michael YAKUBOVSKY, Mississauga (CA); Garvan KEELEY, Toronto (CA)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 12/415,762

(22) Filed: Mar. 31, 2009

Related U.S. Application Data
(60) Provisional application No. 61/041,176, filed on Mar. 31, 2008.

(51) Int. Cl. G06K 9/00

(52) U.S. Cl. 382/137

(57) ABSTRACT

The present disclosure relates to electronic digital files with document security features to prevent duplication of documents. The method may include selecting a source image previously designed, where a specified tone is used to indicate a background area and another specified tone(s) is/are used to indicate at least one security feature(s) area. The method may also include selecting one or more corresponding tiles and/or one or more corresponding functions for (i) the background area and (ii) the at least one security feature(s) area, generating a converted electronic digital file from the source image with the desired security feature(s) and saving the converted electronic digital file in a format suited for use as a stand-alone graphic image or incorporated into other programs ready for output onto the output device.

### CROSS REFERENCE TO RELATED APPLICATIONS

The present application claims the benefit of the filing date of U.S. Provisional Application Ser. No. 61/041,176 filed Mar. 31, 2008, the teachings of which are incorporated herein by reference.

### FIELD OF THE INVENTION

The present disclosure relates to a methodology, apparatus and product, which may provide users the ability to use conventional graphics software programs as a platform and an environment to digitally convert a source file into converted digital document security graphic files incorporating document security features.

### BACKGROUND OF THE INVENTION

As it is well known, there are a wide range of methods and/or products directed to preventing the unauthorized reproduction of original valuable documents, which may involve using relatively common printing processes such as offset printing (lithography), letterpress, flexographic, intaglio and/or gravure processes as well as, recently, the addition of digital output equipment such as laser printers or printer/copiers and/or ink-jet printers and/or commercial sheet/web ink/tonner based digital presses such as but not limited to presses from HP, Kodak, Xerox, Oce, Xeikon, etc. The final printed documents may be produced at almost any print resolution including document security features to prevent counterfeiting of the documents and unauthorized duplication of, for example, but not limited to currency, travelers checks, checks, coupons, RX prescription pads, gift certificates, licenses, passports, personal identification papers, as well as packaging material, etc. Examples of such methods and products may include a copy evident distortion security feature commonly know as VOID pantographs, which may be formed by embedding images and/or moiré inducing patterns in the original documents that are nearly invisible to the naked eye but which become apparent upon photocopying. Further methods and products that may include a hidden covert security feature relate to the use of such covert security features that can be authenticated and/or readable by the use of decoders or verification scanning systems.

In order to produce a printed original document including copy evident distortion VOID pantographs and/or covert authenticable document security features, one may create and produce printable half-tone screens (such as rastered images) using patterns of any shaped dots and/or dashes and/or lines etc. and/or in combinations thereof, in the printing process. Security images relating in the field of copy evident distortion VOID pantographs and/or covert authenticable document security features may require the incorporation of more than one or multiple half-tone screen patterns into a single image file where such single image file can be independently and/or incorporated with other non security related graphic/text to generated a secured printed document(s).

A raster image processor (RIP) is a component that may be used in a printing system. Raster image processing is a process and a means of turning digital information such as a PostScript file into a half-tone screen. However, this half-tone screen may use only one screen pattern. A RIP can be implemented either as a software component of an operating systems or as a firmware program executed on a microprocessor inside a printer, or as standalone hardware RIPs. Traditionally, stand-alone proprietary software and or plug-ins programs have been used to convert source images into half-tone screens containing the copy evident distortion VOID pantographs and/or covert authenticable security images. The halftone screen “dot” placements are relatively precise and may be controlled by sophisticated mathematical/interpolation algorithms coded in the proprietary software linked to the processes. The stand-alone proprietary software and or plug-ins programs used to create the distortion VOID pantographs and/or covert authenticable security images may instruct and/or override the RIP's native half-toning algorithm in order to produce multiple half-tone screens in a single image. However, native RIPs are designed to output half-tone screen using just one screen pattern. Since there may be numerous RIP's on the market coupled with the fact that security images may require the incorporation of more then one halftone screen pattern into a single image file, conflicts between the proprietary software and some RIPs may be common which may cause errors in the final output of the security image with more then one halftone screens. Workarounds and overrides may be needed to overcome these issues. Ghostscript and GhostPCL are examples of software RIPs that maybe incorporated into the workflow to bypass these problems.

Therefore, what may be needed in the art is a relatively user-friendly environment for digitally producing electronic document security graphic files using conventional graphics software programs that may be totally compatible with raster image processors (RIPs) in all kinds of workflow as to avoid issue of conflicts or errors with the onboard RIP.

Moreover, what may be needed in the art are methods and processes for producing such digital electronic document security graphic files using pre-programmed, pre-recorded custom plug-ins to operate within a graphics framework provided by standard graphics programs coded to execute a sequence of routines in the conversion a source image into a digital electronic document security graphic files with one or a combination of security features such as but not limited to copy evident distortion VOID pantographs and/or covert authenticable security images described in public domain, patented and/or patent pending methods and/or processes that require the incorporation of more than one halftone screens pattern onto a single screen.

Additionally, the converted digital electronic security graphic files may be incorporated into any conventional graphics layout program/desktop publishing software such as but not limiting to QUARK EXPRESS®, ADOBE IN-DESIGN®, ADOBE ILLUSTRATOR®, ADOBE PAGEMAKER®, COREL DRAW®, MICROSOFT OFFICE PUBLISHER®, etc. but also, the digital electronic security graphic files may be incorporated into other conventional computer programs such as but not limited to MICROSOFT OFFICE®, SUN OPEN OFFICE®, COREL WORDPERFECT®, ADOBE ACROBAT®, etc. in the document design of the pre-press and/or pre-print stage of the print process. The final document containing the converted digital electronic security graphic files may be put through any pre-press and/or pre-print workflow, etc. without the fear of conflicts or errors with the onboard RIP. The finished files may be ready for output using any output devices such as film and/or CTP (computer to plate) image-setters, use in the common printing processes such as offset printing (lithography), letterpress, flexographic, intaglio and/or gravure, as well as use in the printing process on all digital output devices/equipment such as laser printers or printer/copiers and/or ink-jet printers and/or commercial digital presses at almost any resolution to produce the final printed document with document security features to prevent counterfeiting of documents and unauthorized duplication.

Furthermore, the converted digital electronic security graphic files may reside in a client/server based printer driver as well as the firmware of digital output equipment such as laser (toner) and inkjet printers and/or “all in one” printers/copiers, etc., in which the converted digital electronic security graphic files may be incorporated in a document on demand and printed together in one pass when the document is selected and called to be printed with the converted digital electronic security graphic files via the printer driver and/or printer firmware.

Accordingly, it may be desirable to have a plug-in for, but not limited to, ADOBE PHOTOSHOP® program, which may be capable of transforming any multi-tonal color, grayscale as well as a single tone (such as a black and white image) graphic source image into one electronic file. In one example, one tonal area (say the “white”) may depict the background area and a second tonal area (say the “black”) may depict a distortion VOID pantographs and/or covert authenticable security features or visa-versa, with or without additional masking design feature. The file may be saved as any known electronic file format, compatible for use with any known computer software programs ready for output on all digital output devices/equipment such that when imaged and/or printed the printed document/film/plate will contain non reproducible properties such as copy evident distortion when copied and/or latent covert authenticable images that may be revealed and/or readable with decoding devices or verification scanning systems.

### SUMMARY OF THE INVENTION

An aspect of the present disclosure relates to a method and an apparatus to produce electronic digital files with document security features to prevent duplication of documents, where the resulting printed documents with document security features would be unobvious to the unaided eye upon inspection. A previously designed source image may be selected, where a specified tone may be used to indicate a background area and another specified tone(s) may be used to indicate at least one security feature(s) area. The resolution of an output device may be identified and one or more corresponding tiles and/or one or more corresponding functions for (i) the background area and (ii) the at least one security feature(s) area may be selected. The converted electronic digital file may be generated from the source image with the desired security feature(s). The converted electronic digital file may then be saved in a format suited for use as a stand-alone graphic image or incorporated into other programs ready for output onto the output device.

Another aspect of the present disclosure relates to an article comprising a storage medium having stored thereon instruction. When executed by a machine, the instruction may result in the operation of selecting a source image previously designed, where a specified tone is used to indicate a background area and another specified tone(s) is/are used to indicate at least one security feature(s) area. In addition, the instruction may result in the operations of identifying the resolution of an output device, selecting one or more corresponding tiles and/or one or more corresponding functions for (i) the background area and (ii) the at least one security feature(s) area, generating a converted electronic digital file from the source image with the desired security feature(s), and saving the converted electronic digital file in a format suited for use as a stand-alone graphic image or incorporated into other programs ready for output onto the output device.

### BRIEF DESCRIPTION OF THE DRAWINGS

The above-mentioned and other features and advantages of this invention, and the manner of attaining them, will become appreciated and be more readily understood by reference to the following detailed description of one embodiment of the invention in conjunction with the accompanying drawings, wherein:

FIG. 1 shows one example of an embodiment, an original document in the form of a check, incorporating a distortion security screen where the background image and hidden warning message image may be presented as a uniform tone to the eye.

FIG. 2 shows the same security document of FIG. 1 after it has been photocopied revealing security screen such as the word “VOID”, which is exemplary of an original document secured with a patented or public domain distortion technology most commonly referred to as a “VOID PANTOGRAPH”.

FIG. 3 shows the same security document of FIG. 1 being authenticated with a decoder device to reveal the hidden indicia “VALID”, which is exemplary of an original document secured with a patented or public domain covert hidden security technology such as but not limiting to what is commonly referred to as “SCRAMBLE INDICIA”.

FIG. 4 is a close up example such as described in for example, but not limited to, U.S. Pat. Nos. 4,227,720, 4,265,469, 4,310,180 and 4,341,404, the teachings of which are incorporated herein by referenced, directed to the field of “VOID PANTOGRAPH” distortion techniques such as the use of a “large dot-small dot pattern”, wherein 11B represents the background screen in the original document using the “small dot pattern” and 11A represents the security screen of the hidden warning message “VOID” image area in the original document using the “large dot pattern”.

FIG. 5 is another close up example such as described in, for example, but not limited to, U.S. Pat. Nos. 5,018,767, 5,193,853, and 5,707,083, the teachings of which are incorporated herein by reference, directed to the field of “VOID PANTOGRAPH” distortion techniques such as the use of a “line screen pattern”, wherein 11D represents the background screen in the original document using a “line screen pattern” in a predetermined lines per inch spacing and line angles and 11C represents the security screen of the hidden warning message “VOID” image area in the original document using a “line screen pattern” in another predetermined lines per inch spacing and line angles.

FIG. 6 is yet another close up example such as described in, for example, but not limited to, U.S. Pat. No. 5,788,285, the teachings of which are incorporated herein by reference, directed to the field of “VOID PANTOGRAPH” distortion techniques such as the use of a “dash line screen pattern”, wherein 11F represents the background screen in the original document using a “line screen pattern” in a predetermined lines per inch spacing and line angles and 11E represents the security screen of the hidden warning message “VOID” image area in the original document using a “line screen pattern” in another predetermined lines per inch spacing and line angles.

FIG. 7 is a close up example such as described in, for example, but not limited to, U.S. Pat. No. 3,937,565, the teachings of which are incorporated herein by reference, directed to the field of latent covert techniques, which may be referred to as “scramble indicia”, which may be revealed with decoding devices or verification scanning systems, wherein 21B represents the background screen in the original document and 21A represents the security screen of the hidden covert image in the original document.

FIG. 8 is another close up example such as described in U.S. Pat. No. 7,367,593 in the field of latent covert techniques that are revealed with decoding devices or verification scanning systems, 21D represents the background screen in the original document, 21C represents the security screen of the hidden covert image in the original document.

FIG. 9 shows an example of AM (Amplitude Modulated) halftone screening and in this example uses dots as elements arranged in specific line frequency and line angle (in this example at 45 degree) whereby the halftone screen represents continuous “gray tone”.

FIG. 10 shows another example of AM (Amplitude Modulated) halftone screening also using dots as elements arranged in a higher line frequency and line angle (in this example at 45 degree), than in FIG. 9, whereby the halftone screen represents the same continuous “gray tone” as in FIG. 9. One can see the size of the elements is smaller but the line frequency is higher in order to produce the same continuous “gray tone” as seen in FIG. 9.

FIG. 11 shows an example of AM (Amplitude Modulated) halftone screening using continuous lines as elements arranged in specific line frequency and line angle (in this example at 45 degree) whereby the halftone screen represents same continuous “gray tone” as in FIGS. 9 and 10.

FIG. 12 shows another example of AM (Amplitude Modulated) halftone screening also using continuous lines as elements arranged in a higher line frequency and line angle (in this example at 45 degree), than in FIG. 11, whereby the halftone screen represents the same continuous “gray tone” as in FIGS. 9, 10 and 11. One can see the width of the line elements is thinner but the line frequency is higher in order to produce the same continuous “gray tone” in FIGS. 9, 10 and 11.

FIG. 13 shows a typical FM (Frequency Modulated) halftone screening using the same size dots as elements arranged in a random pattern whereby the halftone screen represents the same continuous “gray tone” as in FIGS. 9, 10, 11 and 12. In an FM screen, the size of the dots elements may be the same size; however, the amount of dots may increase to produce higher continuous “gray tone” value. Another version of a FM (Frequency Modulated) halftone screening (not shown) where the halftone dot elements may be arranged in a random pattern wherein the size of the dots and the frequency or the number of the dots may be variable to produce the desired continuous “gray tone” value.

FIG. 14 shows a Black and White electronic source image file to be converted into an electronic security graphic image such that when printed, the document may have non-reproducible properties such as distortions when copied and/or latent covert images that can be reveal with decoding devices or verification scanning systems.

FIG. 14A shows the converted electronic file of FIG. 14, with a security graphic image in the field of “VOID PANTOGRAPH” distortion techniques such as those as described in, for example, but not limited to U.S. Pat. Nos. 4,227,720, 4,265,469, 4,310,180 and 4,341,404, the teachings of which are incorporated herein by reference, where the first tone (in FIG. 14 “white”) is converted into the background area and the second tone (in FIG., the “black”) is converted into the hidden “distortion” security feature area to create the electronic security graphic image file such that when printed the document will have non-reproducible properties such as distortions when copied.

FIG. 14B shows the converted electronic file of FIG. 14, with security graphic image in the field of latent covert techniques that may be revealed with decoding devices or verification scanning systems as described in, for example, but not limited to, U.S. Pat. No. 7,367,593, the teachings of which are incorporated herein by reference, where the first tone (in FIG. 14 the “white”) is converted into the background area and the second tone (in FIG. the “black”) is converted into the hidden “covert” security feature area to create the electronic security graphic image file such that when printed the document will have latent covert images that can be reveal or readable with decoding devices or verification scanning systems.

FIG. 15 shows an example of a halftone screen, wherein 31A represents a repeatable pattern tile used to fill the entire background area to generate 11B in FIG. 4, which is also illustrated as the “white” region of FIG. 14, the background area of a security graphic image.

FIG. 16 shows an example of a halftone screen, wherein 31B represents a repeatable pattern tile used to fill the entire region assigned as the hidden security feature area to generate 11A of FIG. 4, which is also illustrated as the “black” region of FIG. 15, the hidden “distortion” security feature area to create the electronic security graphic image file such that when printed the document may have non-reproducible properties such as distortions when copied and/or the hidden “covert” security feature area to create the electronic security graphic image file such that when printed the document will have latent covert images that can be reveal or readable with decoding devices or verification scanning systems.

FIG. 17 shows another example of a halftone screen, wherein 31C represents a repeatable pattern tile used to fill the entire background area to generate 11F in FIG. 6, which is also illustrated as the “white” region of FIG. 14, the background area of a security graphic image.

FIG. 18 shows another example of a halftone screen, wherein 31D represents a repeatable pattern tile used to fill the entire region assigned as the hidden security feature area to generate 11E of FIG. 6, which is also illustrated as the “black” region of FIG. 15, the hidden “distortion” security feature area to create the electronic security graphic image file such that when printed the document may have non-reproducible properties such as distortions when copied and/or the hidden “covert” security feature area to create the electronic security graphic image file such that when printed the document will have latent covert images that can be reveal or readable with decoding devices or verification scanning systems.

FIG. 19 shows another example of a halftone screen, wherein 31E represents the repeatable pattern tile used to fill the entire background area to generate what is needed as 21B in FIG. 7, which is also illustrated as the “white” region of FIG. 14, the background area of a security graphic image.

FIG. 20 shows another example of a halftone screen, wherein 31F represents the repeatable pattern tile used to fill the entire region assigned as the hidden security feature area to generate what is needed as 21A of FIG. 7, which is also illustrated as the “black” region of FIG. 15, the hidden “distortion” security feature area to create the electronic security graphic image file such that when printed the document may have non-reproducible properties such as distortions when copied and/or the hidden “covert” security feature area to create the electronic security graphic image file such that when printed the document will have latent covert images that can be reveal or readable with decoding devices or verification scanning systems.

FIG. 21 shows another embodiment of a halftone screen, wherein 31G represents the repeatable pattern tile used to fill the entire background area to generate what is needed as 21D in FIG. 8, which is also illustrated as the “white” region of FIG. 14, the background area of a security graphic image.

FIG. 22 shows another embodiment of a halftone screen, wherein 31H represents the repeatable pattern tile used to fill the entire region assigned as the hidden security feature area to generate what is needed as 21C of FIG. 8, which is also illustrated as the “black” region of FIG. 15, the hidden “distortion” security feature area to create the electronic security graphic image file such that when printed the document may have non-reproducible properties such as distortions when copied and/or the hidden “covert” security feature area to create the electronic security graphic image file such that when printed the document will have latent covert images that can be reveal or readable with decoding devices or verification scanning systems.

FIG. 23 illustrates an example of a process of providing a converted electronic security graphic file.

FIG. 24 illustrates an example of the present invention relating to an article of machine readable media in relation to a processor and a user interface.

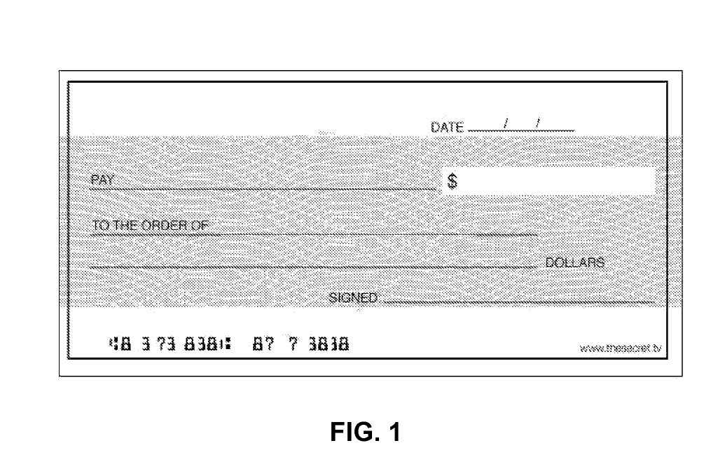

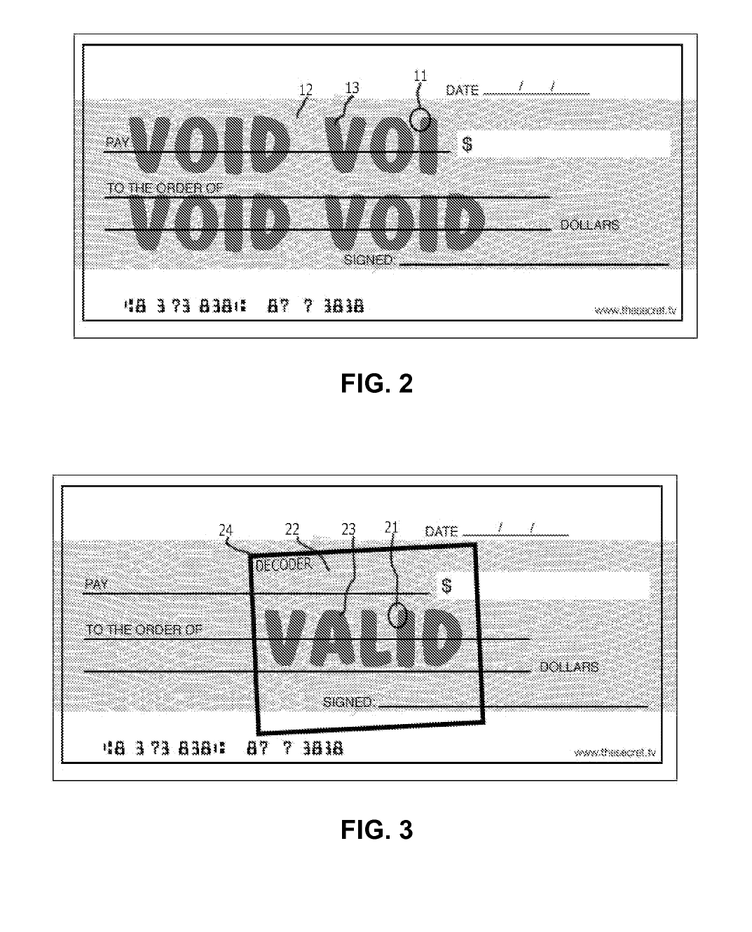

### DETAILED DESCRIPTION

The present disclosure relates to providing a methodology, apparatus and product to improve the workability in creating digital electronic security graphic files which may provide users the ability to use conventional graphics software programs as a platform and/or an environment to digitally produce an electronic graphic file that may incorporate document security features. Such document security features may include, but not be limited to, copy evident features, commonly known as “void pantographs”, which may be distorted when photocopied or scanned, and/or latent covert images, such as but not limited to, features commonly known as “scramble indicia”, which may be revealed with decoding devices or verification scanning systems.

The digitally produced electronic graphic files may be output onto film and/or plate image setters used in the common printing processes such as offset printing (lithography), letterpress, flexographic, intaglio and/or gravure, as well as onto digital output equipment such as laser printers or printer/copiers and/or ink-jet printers and/or commercial digital presses. The files may be produced at any resolution to create the finish printed document with document security features to prevent counterfeiting of documents and/or unauthorized duplication. Additionally, the produced digital electronic security graphic files may be incorporated into any conventional graphics layout programs such as but not limiting to QUARK EXPRESS®, ADOBE IN-DESIGN®, ADOBE ILLUSTRATOR®, etc. In addition, the digital electronic security graphic files may be incorporated into other conventional programs, such as but not limited to, MICROSOFT OFFICE®, COREL WORDPERFECT®, etc., and placed in a document during pre-press and/or pre-print stages of the print process.

In one embodiment of the present invention, a plug-in operating within a graphics framework may be provided by a standard graphics program. A “plug-in” may be understood herein as a software library of routines that may be invoked during run time in an industry-standard manner by a more general-purpose program. A non-limiting example may include a plug-in for the ADOBE PHOTOSHOP® program.

Conventional processes may be limited to proprietary software that may be linked and associated to particular technology. The deployment of the software used to deliver such technology may be complicated for most users with limited training as well as problematic with various print workflows without “work-around” to avoid issue of conflicts or errors with the users' onboard RIPs.

However, a plug-in configured to operate within a graphics framework provided by a standard graphics program may allow for simplification of the process of converting source images into digital document security graphic files. A “plug-in”, again, may be understood as a software library of routines that are invoked at run time in an industry-standard manner by a more general-purpose program. A non-limiting example is a plug-in for the ADOBE PHOTOSHOP® program.

In addition, digital electronic document security graphic files may be produced incorporating various known document security features in a file format that may be easily printed on high resolution digital output devices from film and/or plate image-setters to laser printers or printer/copiers and/or ink-jet printers and/or commercial digital presses at any resolution.

The digitally converted electronic document security graphic files may include in any known electronic file format such as but not limited to, BMP, RLE, GIF, EPS, JPEG, PCT, PNG, TIFF, EMF, WMF, RAW, etc. The converted electronic document security graphic file(s), with one or more hidden copy evident distortion features and/or covert security features, may be output onto film or plates using digital output image setters. The files may then be used in printing processes such as offset printing (lithography), letterpress, flexographic, intaglio and/or gravure processes as well as digital output equipment such as laser printers or printer/copiers, as well as multi-functional devices, and/or ink-jet printers, toner printers, wax printers and/or commercial digital presses. In addition, the files may be produced at any resolution creating the final printed document with document security features to prevent counterfeiting of documents and unauthorized duplication.

Additionally, the electronic document security image files produced by the present invention may incorporate document security technologies such that when the digitally converted electronic document security graphic files including embedded hidden documents are printed, the document security features and its background are difficult to differentiate when being inspected with the unaided eye.

In some examples, a RIP (raster image processor) may be used to process an image generated by a computer application to produce a desired image on a digital output device such as in image setters, used in standard press processes such as but not limiting to offset printing (lithography), letterpress, flexographic, and/or gravure processes, as well as in most digital printers/copiers, digital presses and DI (direct image) presses. In the case of less expensive desktop digital output devices such as low-end inkjets and laser printers, where one may not find a RIP, one may instead rely on a printer driver to communicate between the application and the desktop printing device.

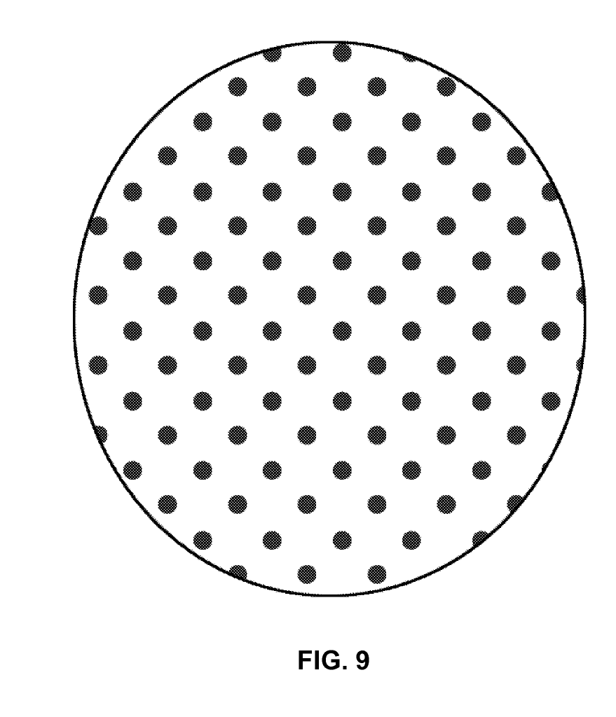

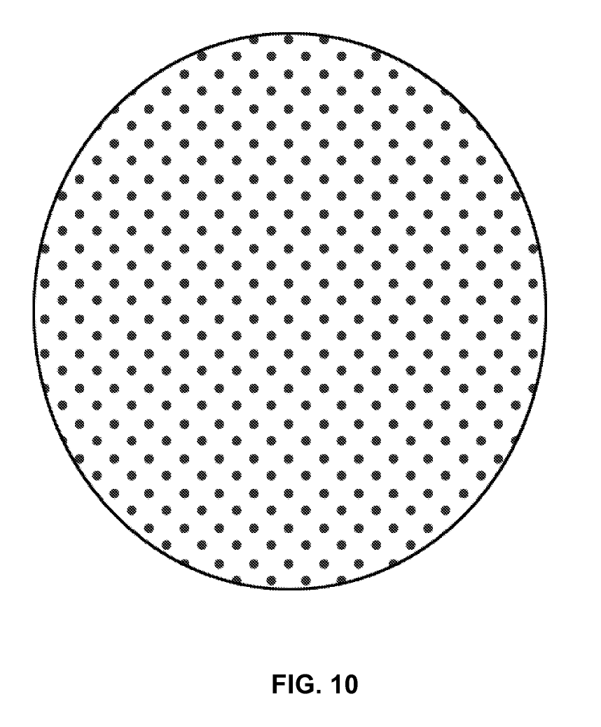

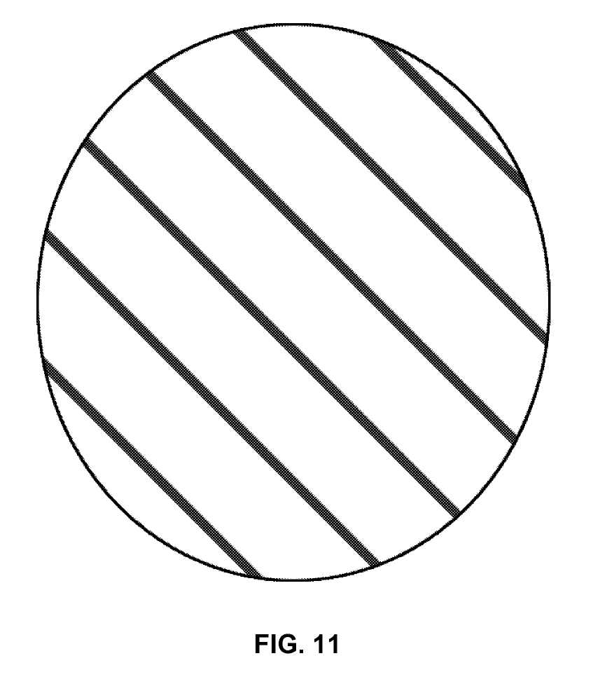

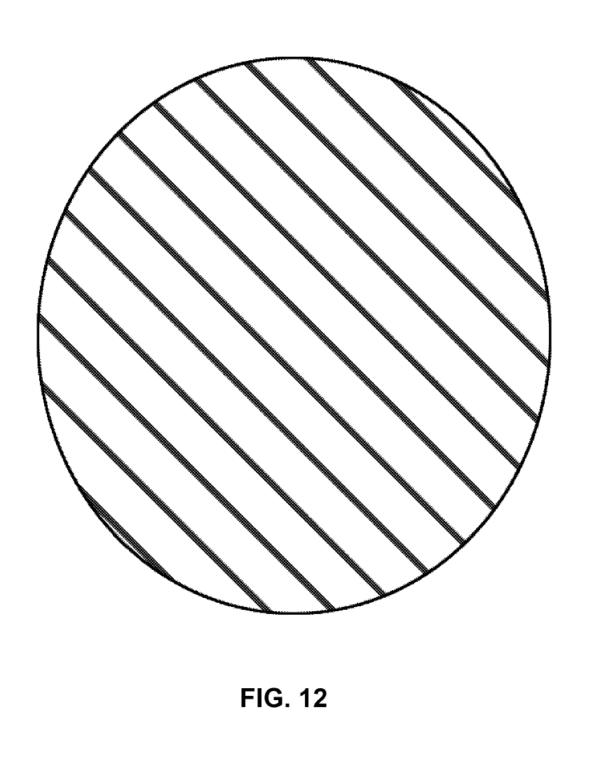

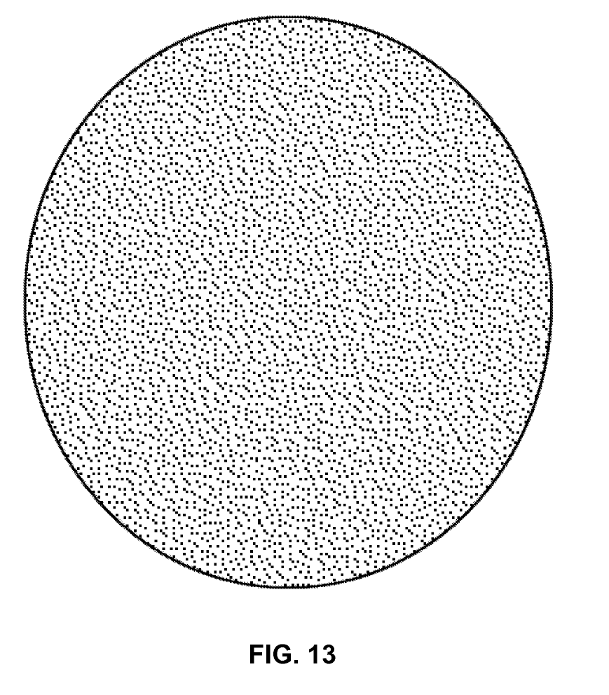

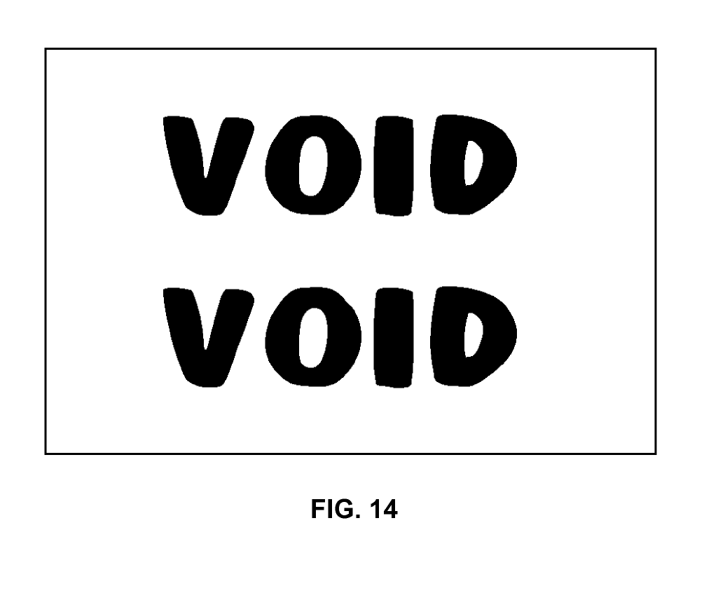

The ripping process may convert digital information such as a PostScript file into a raster image. That is, the RIP may take the digital information about fonts and graphics that describes the appearance of the electronic file and may translate it through it's algorithm into a rasterized image composed of individual dots (halftone screen) that the imaging device (such as the printer or an image setter) may output. Ripping may also be printer/output device specific, in that the writing characteristics of the printer/output to be used may be taken into account in producing the ideal print image. However, this halftone screen image may only be one screen pattern as dictated by its algorithm when the digital information is converted into a rasterized image. In most raster images, elements such as dots of various shapes, dashes, and/or lines may be placed in a specified angle and/or line frequency and may only vary in size where the larger the elements, the higher the “gray tone” value as illustrated in FIGS. 9, 10, 11, and 12. In another example, a raster image may utilize elements such as dots of the same size in a random pattern and only the amount of elements change so that a greater amount of elements will reflect a higher “gray tone” value as illustrated in FIG. 13.

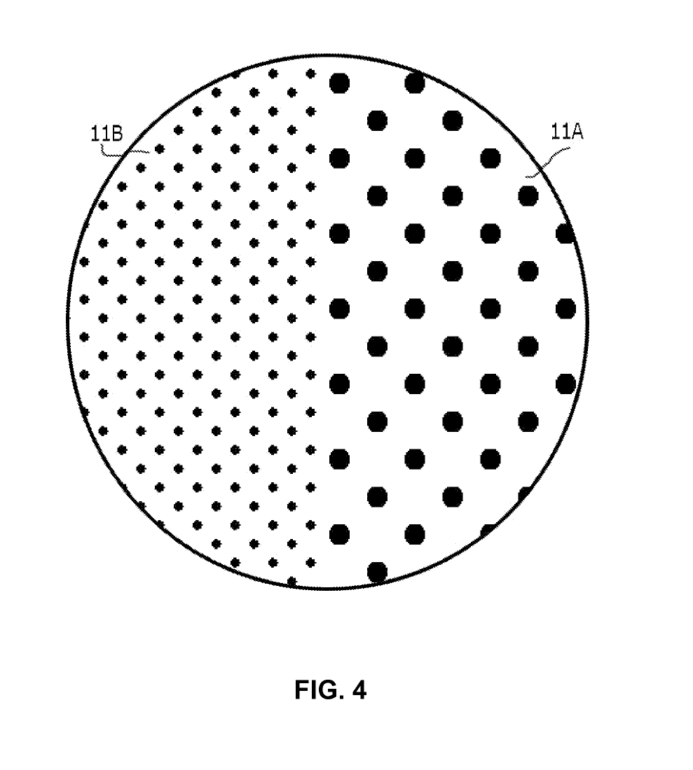

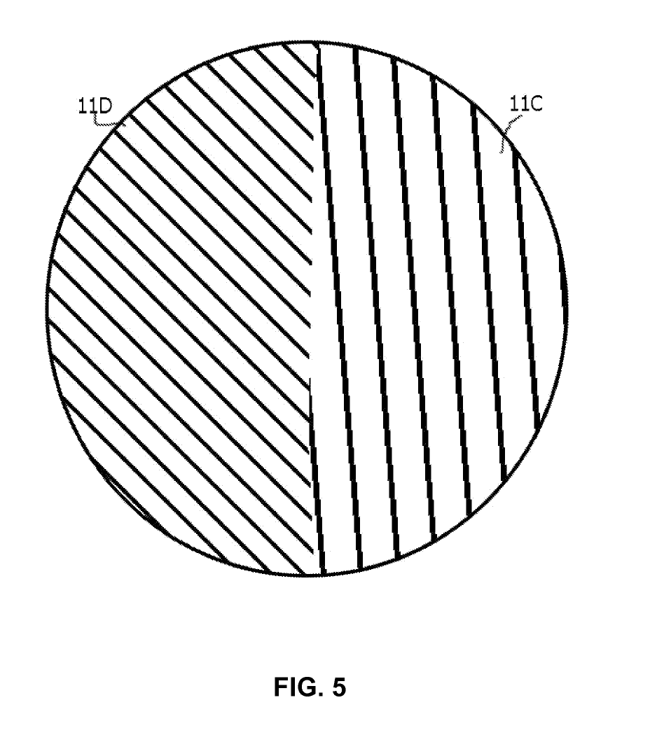

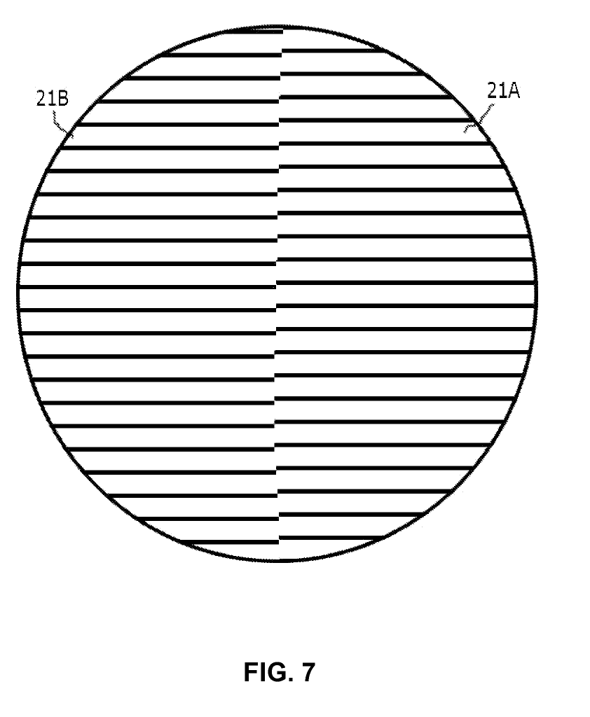

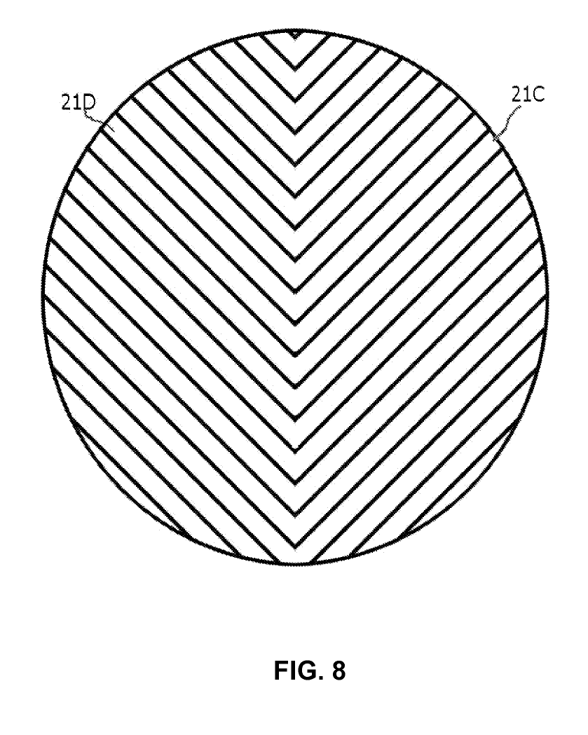

Upon examination, document security features such as copy evident security features commonly known as “void pantographs”, which may be distorted when photocopied or scanned as illustrated in FIGS. 4, 5 and 6 or other document security features with latent covert authenticable images, such as but not limited to, features commonly known “scramble indicia” that are revealed or readable with decoding devices or verification scanning systems as shown in FIGS. 7 and 8, one may see that these document security features require a single halftone screen comprised of multiple half-tone screening patterns. In these illustrations, the background areas may contain placement of halftone elements, which may be different from the placement of halftone elements in the security image area.

As previously stated, most proprietary software that may be used to generate an output with document security features may be coded to override the RIP's native rasterization process in order to reassign the required screening processes and/or to create the rasterized image that may be needed for multiple distinctively different areas vis-à-vis the background areas and the hidden security feature areas.

The present disclosure contemplates a simple and efficient methodology, apparatus and product to improve the workability in creating and generating digital electronic security graphic files which may allow users the ability to use conventional graphics software programs as a platform and an environment to digitally convert electronic graphic files into electronic security graphic files incorporating document security features as shown in FIGS. 4, 5, 6 7 and 8. The methods and processes for producing such converted electronic document security graphic files using a pre-programmed, pre-recorded custom “plug-ins” to operate within a graphics framework provided by standard graphics programs coded to execute a sequence of routines in the conversion of a source image into any document security feature such as but not limited to a copy evident distortion commonly known as a “VOID” pantograph and/or a covert security image that may require the incorporation of more than one halftone screens pattern onto a single file. In some examples, the present invention may include a plug-in operating within a graphics framework provided by a standard graphics program. Once again, a “plug-in” may be understood as a software library of routines, which may be invoked at run time in an industry-standard manner by a more general-purpose program. A good example but not limiting to would be a plug-in for the ADOBE PHOTOSHOP® program.

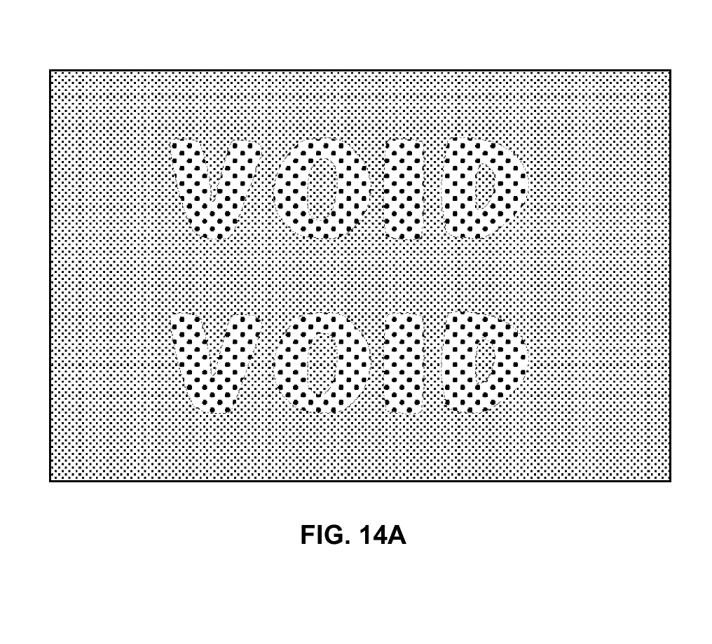

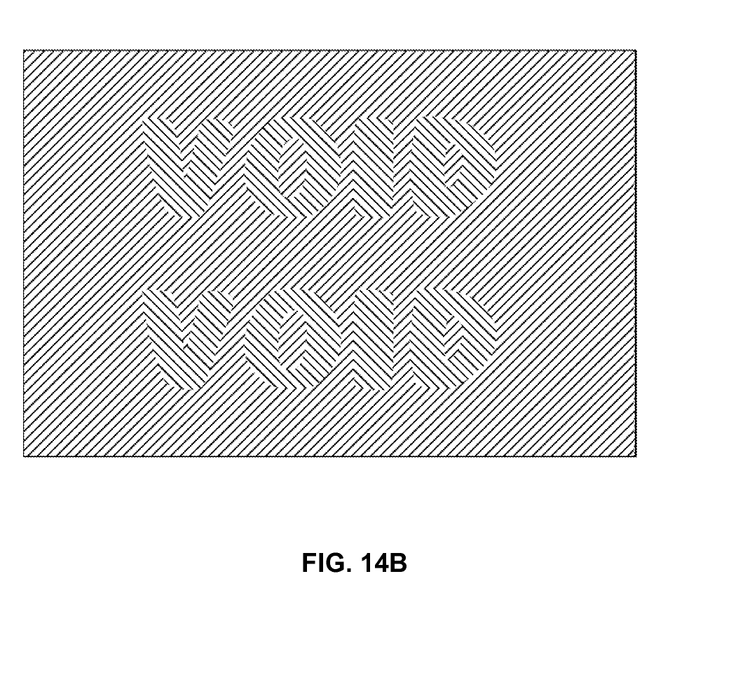

In one example, a multi-tonal color and/or grayscale and/or a black and white electronic source image file as depicted in FIG. 14 may be converted into an electronic security graphic image such as the one described in FIGS. 4, 5, 6, 7 and 8. The converted electronic security graphic image file, when printed in a document, may have non-reproducible properties such as distortions when copied and/or latent covert images that may be revealed or readable with decoding devices or verification scanning systems. The first tone (in FIG. 14 the “white”) may be assigned and converted into a background area. The second tone (in FIG. 14 the “black”) i.e., the two “VOID” images, may be assigned and converted into the hidden security feature. The converted electronic security graphic image file when printed in a document may have non-reproducible properties, such as copy evident distortions when copied as shown in FIG. 14A and/or the document may have latent covert security features that may be revealed or readable with decoding devices or verification scanning systems as shown in FIG. 14B and/or with both security features.

In some examples, to accomplish the task of digitally generating a converted electronic security graphic file that when printed, may contain hidden security features having non-reproducible properties such as copy-evident distortions when copied and/or latent covert authenticable images that can be revealed or readable with decoding devices or verification scanning systems, one may start with a basic source file that may be multi tonal color and/or grayscale and/or a black and white containing the desired document security features. The inventive methods and processes may then use a pre-programmed, pre-recorded custom plug-ins to operate within a graphics framework provided by standard graphics programs, coded to execute a sequence of routines that are invoked at run time in an industry-standard manner of routines, to convert the source image by using various pattern tiles residing in the pre-programmed, pre-recorded custom plug-ins. Such tiles may be selected and assigned to each of the defined areas, including, for example, the background area(s) or security feature area(s) represented by a specific tone (including a lack thereof) in the source image such as “white” for the background and “black” for the security feature areas. In another example, a multi-tonal source image may contain 3 or more tones with one tone assigned as the background and the second tone assigned as the copy evident distortion feature and the third tone as the latent covert feature. The various pattern tiles residing in the pre-programmed, pre-recorded custom plug-ins used in the present inventive methods and processes may be created to reflect the required halftone screening and may, in some example, be grouped and/or assigned as either background tiles or security feature tiles.

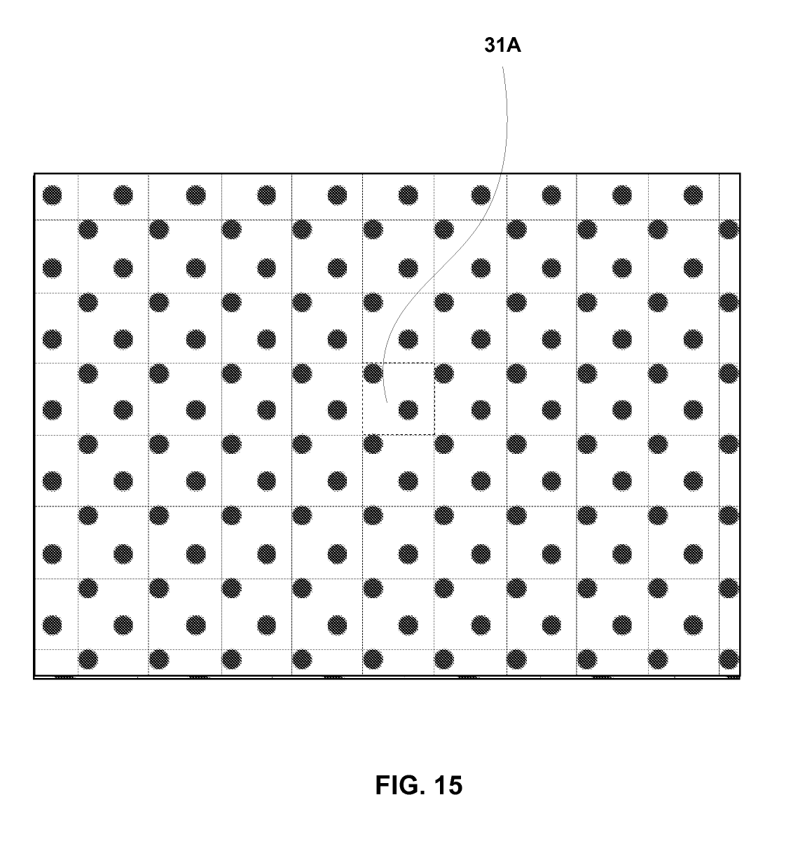

As an example, FIG. 15 illustrates a pattern tile (31A) created to imitate the halftone screening described in for example, but not limited to, U.S. Pat. Nos. 4,227,720, 4,265,469, 4,310,180, and 4,341,404, the teachings of which are incorporated herein by reference. In such example, the halftone screening may be made up of dots, arranged at a certain line frequency (e.g., 133 lines per inch) and at a particular line angle (e.g., 45 degrees) forming a desired X % “gray tone” which may be assigned to the background of the source image. Such screens may be accomplished by designing a tile which may be approximately 0.01 inches×0.01 inches, containing 2 dots approximately 0.003 inches in diameter representing the halftone screen when printed.

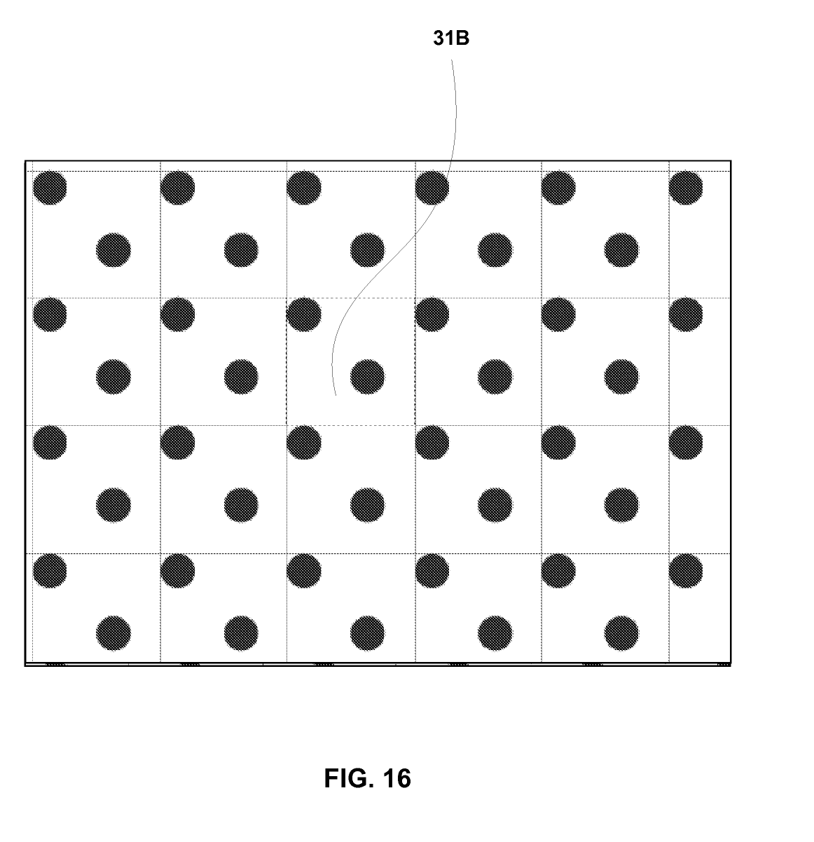

FIG. 16 illustrates another example of a pattern tile (31B) created to initiate halftone screening where the halftone screening may be formed of dots arranged at certain line frequency (e.g., 67 lines per inch) and at a particular line angle (e.g., 45 degrees) to produce a halftone screen also exhibiting similar or the same X % “gray tone”, which may be assigned to the security feature area of the image. This may be accomplished by designing a tile which is approximately 0.02 inches×0.02 inches, containing 2 dots approximately 0.006 inches in diameter. The security feature areas of the source image that when combined with the screening illustrated in FIG. 15 may produce one single file with multiple halftone screens as shown in FIG. 14A or FIG. 4. The converted electronic security graphic file may mimic the function of the RIP, whereby the RIP may no longer be required to produce the rasterized image, therefore avoiding any output error issue with the user's onboard RIP.

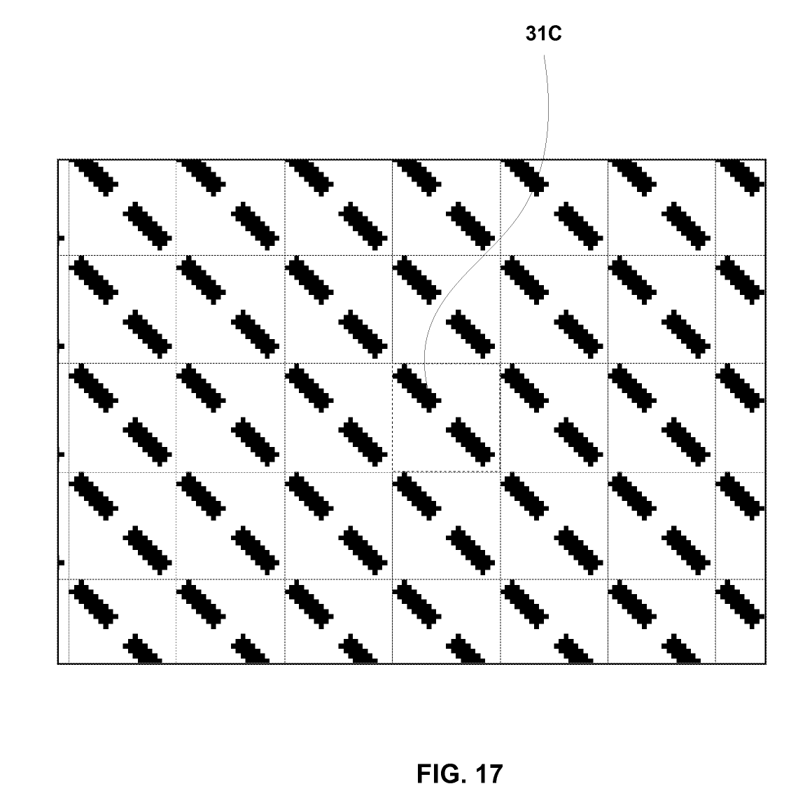

In another example, FIG. 17 illustrates the pattern tile (31C) created to imitate the halftone screening described in, for example, but not limited to, U.S. Pat. No. 5,788,285, the teachings of which are incorporated herein by reference. As illustrated, the halftone screening may be formed from of dashes, arranged at a certain line frequency (e.g., 120 lines per inch) and at a particular line angle (e.g., at 45 degrees). The halftone screen may be produced by a tile of approximately 0.01 inches×0.01 inches, including 2 dashes approximately 0.001 inches×0.005 inches. The halftone screen, when printed, may create a desired X % “gray tone” that may be assigned to the background of the source image.

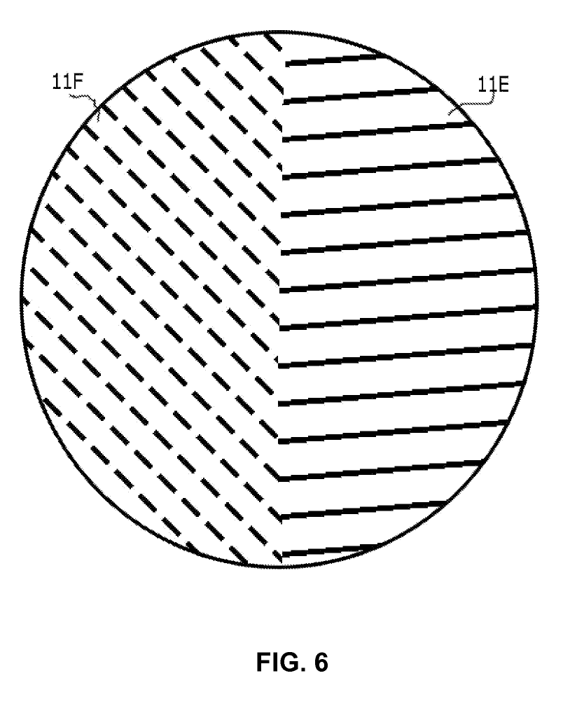

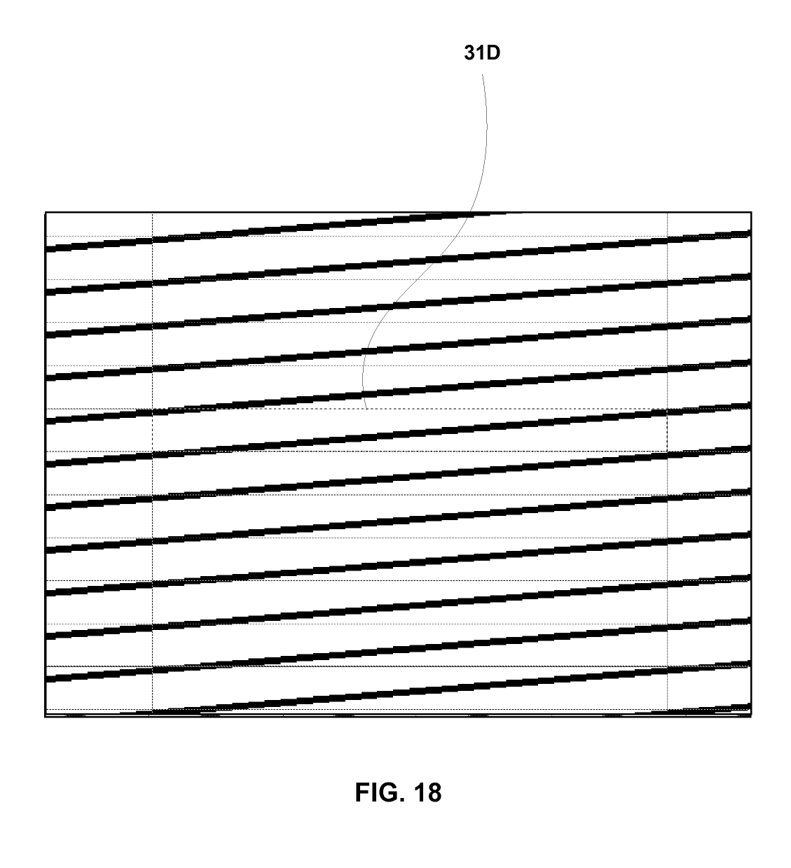

FIG. 18 illustrates a pattern tile (31B) created to initiate a halftone screen where the halftone screen may be formed of lines arranged at certain line frequency (e.g., 100 lines per inch) and at a particular line angle (e.g., 5 degrees). This example may be accomplished by designing a tile which is approximately 0.13 inches×0.01 inches, containing 2 line patterns approximately 0.001 inches thick. The halftone screen may also form, when printed, a desired X % “gray tone” assigned to the security feature areas of the source image. When combined with the screening illustrated in FIG. 17 this halftone may produce a single file with multiple halftone screens as shown in FIG. 6. The converted electronic security graphic file may mimic the function of the RIP whereby the RIP may no longer be required to produce the rasterized image; therefore, avoiding any output error issue with the user's onboard RIP.

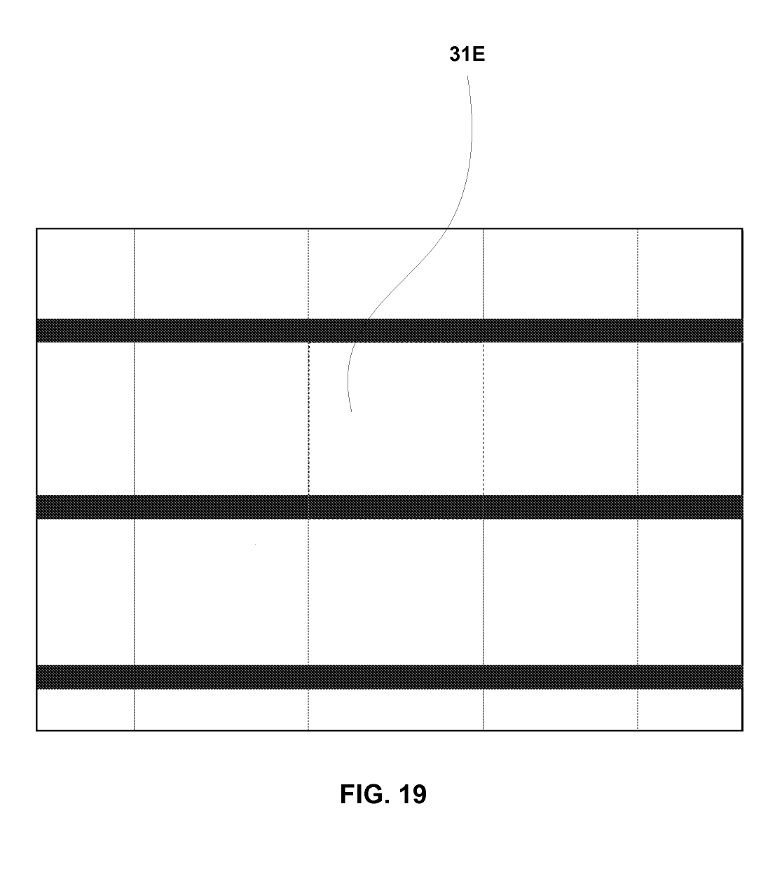

In a further example, FIG. 19 illustrates the pattern tile (31E) created to imitate the halftone screening described in, for example, but not limited to U.S. Pat. No. 3,937,565, the teaching of which are incorporated herein by reference. The halftone screening may be formed of lines and/or dots, arranged at a certain line frequency (e.g., 150 lines per inch) and at a particular line angle (e.g., 0 degrees). The halftone screening may be formed by designing a tile, which is approximately 0.0066 inches×0.0066 inches, containing a line (or row of dots) where the thickness of the line (or the size of the dots) may be determined by the desired “gray tone” required by the user and is assigned to the background of the source image.

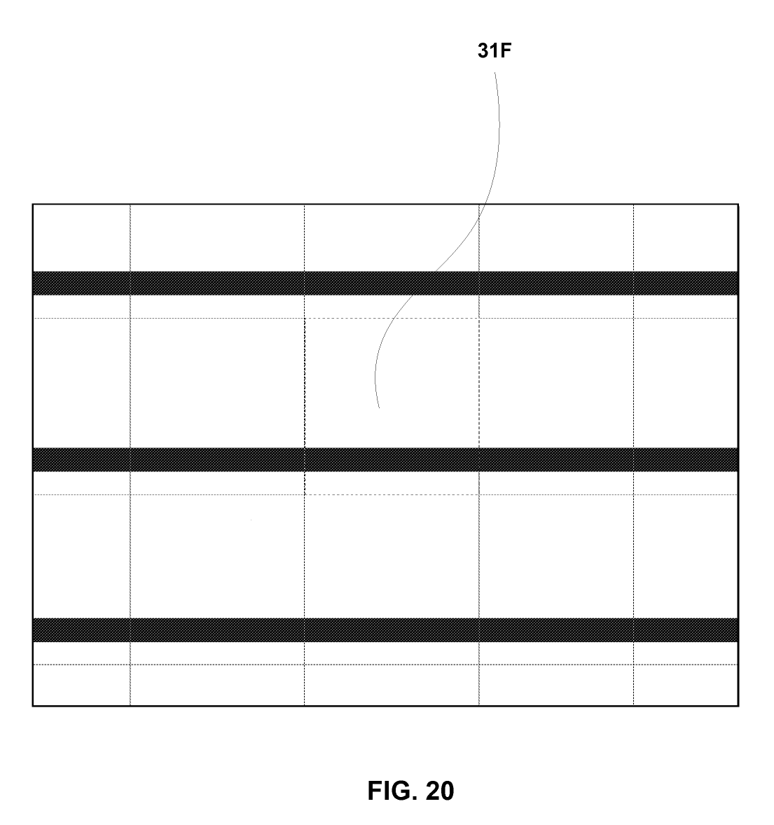

FIG. 20 illustrates a pattern tile (31F) created to initiate the halftone screening, which may be formed from lines arranged at a certain line frequency (e.g., 150 lines per inch) and at a particular line angle (e.g., 0 degree). Such frequency and angle may be substantially the same as FIG. 19; however, the line (or row of dots) may be shifted slightly from the original line position in FIG. 19. Such halftone screen may create a similar desired “gray tone” as required by the user and may be assigned to the security feature areas of the source image. When combined with the screening illustrated in FIG. 19, a single file may be produced with multiple halftone screens as shown in FIG. 7. The converted electronic security graphic file may mimic the function of the RIP whereby the RIP may no longer be required to produce the rasterized image; therefore, avoiding any output error issue with the user's onboard RIP.

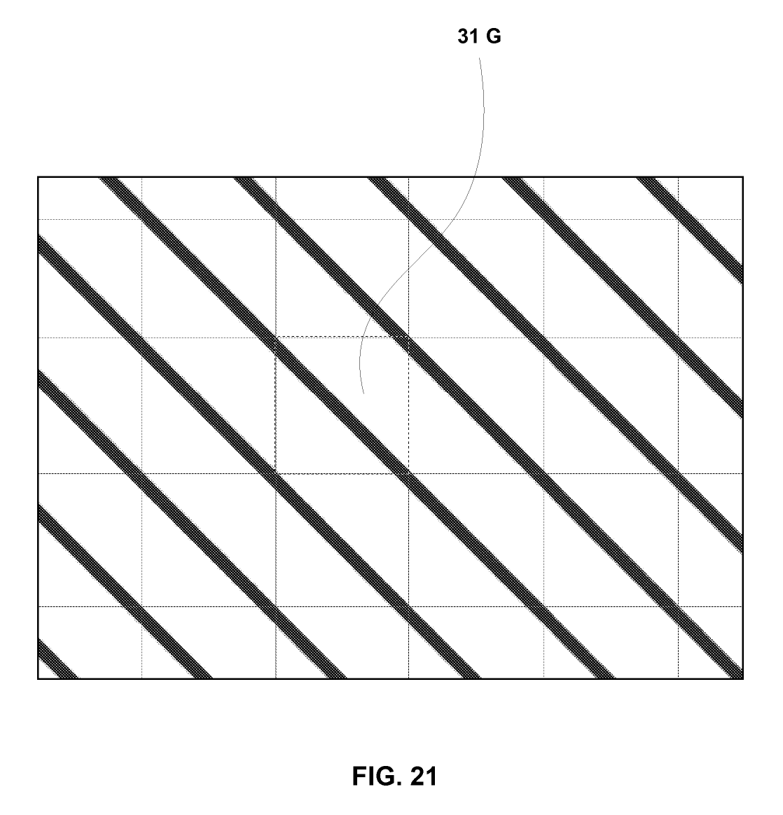

As another example, FIG. 21 illustrates a pattern tile (31G) created to imitate the halftone screening described in, for example but not limited to, U.S. Pat. No. 7,367,593, the teachings of which are incorporated by reference. The halftone screening may be formed of lines, arranged at a certain line frequency (e.g., 200 lines per inch) and at a particular line angle (e.g., 45 degree). Such a halftone screen may be formed by designing a tile, which may be approximately 0.006 inches×0.006 inches. The tile may include a line, wherein the thickness of the line may be determined by the desired “gray tone” value of “X %”, when printed as required by the user. Such tiles may be assigned to the background of the source image.

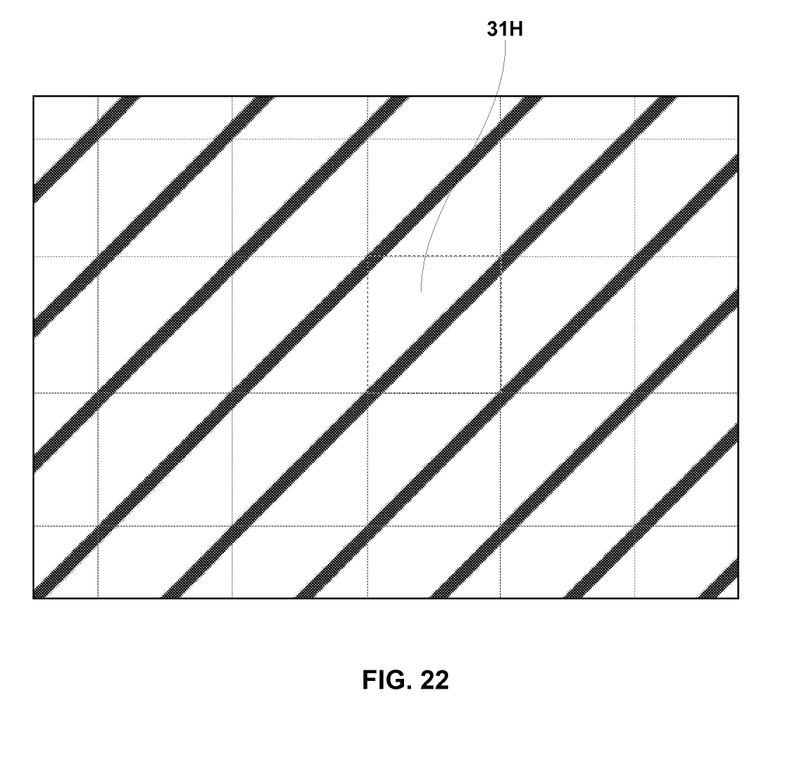

FIG. 22 illustrates a pattern tile (31H) created to initiate the halftone screening where the halftone screening may be made up of lines arranged at certain line frequency (e.g., 200 lines per inch) and at a particular line angle (e.g., 135 degree). Such tiles may also contain a line where the thickness of the line may be determined by the same desired “gray tone” of “X %” value when printed as required by the user. Such tiles may be assigned to the background of the source image assigned to the security feature areas of the source image. When combined with the halftone screening illustrated in FIG. 21, the halftone screens may produce one single file with multiple halftone screens as shown in FIG. 8.

It may be appreciated that depending on the desired “gray tone” value or halftone screen, various elements may be utilized to form the halftone screens, such as lines, dots, dashes, circles, as well as other geometric shapes. In addition, the element frequency (i.e., dot and/or line frequency) may be in the range of 10 to 400 lines per inch, including all values and increments therein, and that the line angle may be in the range of 0 to 180 degrees may be contemplated herein, including all values and increments therein. The tiles may also be adjusted in dimension to accommodate the halftone elements and/or the density of such elements. Furthermore, the tiles may be of a number of shapes, including square, rectangular, octagonal, etc. depending on the type of halftone screen patterns. It may also be appreciated that the arrangements described above may be reversed or additional halftone screens may be provided in a single file. For example, a single file may include 3 or more halftone screens in a single file.

The various tile patterns may be previously generated and saved in memory, (i.e., pre-programmed or pre-recorded). The patterns may be chosen, for example, by a desired printed “gray tone” value or desired security feature, formed by large dot-small dot patterns, line screen patterns, dash line screen patterns, forms of scramble indicia and combinations thereof.

The converted electronic security graphic file from the original electronic source image file as depicted in FIG. 14 may allow the RIP, whereby the RIP may no longer be required to produce the finished image, which can be output on any electronic output devices, avoiding any output error issue with the user's onboard RIP. This methodology, apparatus and product allows for the incorporation of more than one halftone screens pattern using any kind of screen elements such as dots of any shape, size with or without microscopic design/text and/or, lines of any size, which are continuous, broken, with or without microscopic design/text etc., onto a single printed document.

In some examples, the converted electronic security graphic files may be formed using native processes and functions provided in conventional software programs, including those listed above. Furthermore, the converted electronic digital files may be set to the same resolution (i.e., 100% of the resolution of the corresponding output device) or fractions of the output resolution of the output device. It may also be appreciated that the converted electronic security graphic files may be saved in a variety of formats, including those listed above, or may reside in a client/server based printer driver as well as in the firm ware of digital output equipment.

It may further be appreciated that the converted electronic digital files may be selected on-demand for output with or without other document content. In addition, it may be appreciated that the source image may be provided in a single bit file format or a multi-bit gray scale or color image file.

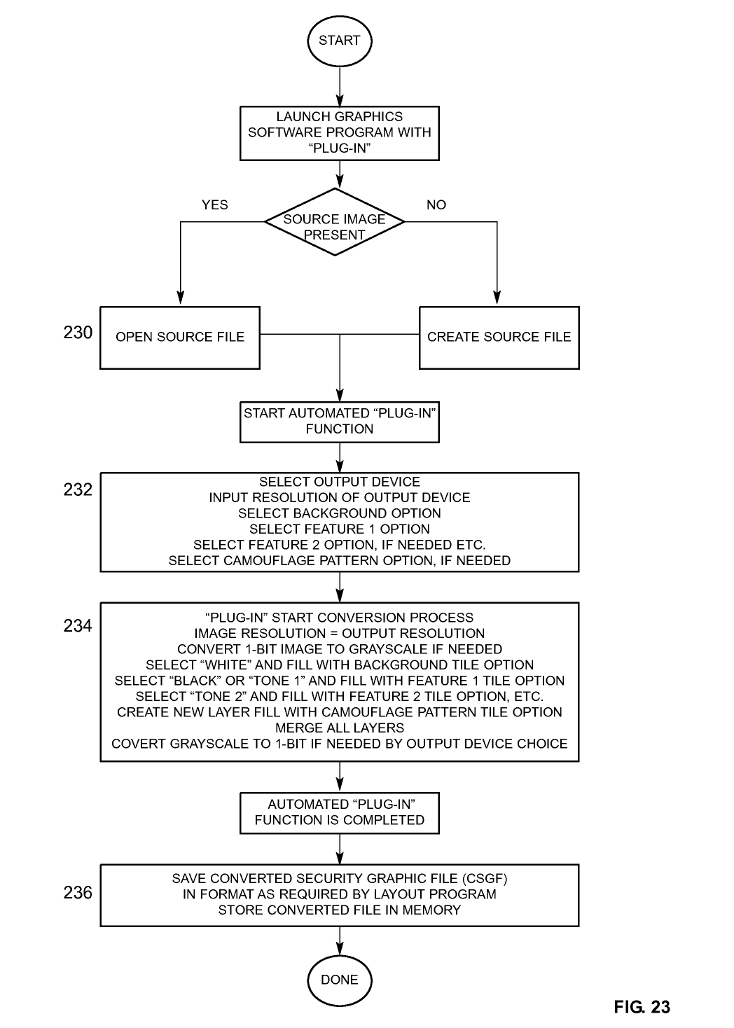

An example of a process for providing a converted electronic security graphic file from a source image incorporating the required halftone screen elements is illustrated in FIG. 23. The process may begin with providing a source image at 230 once a graphics program including a “plug in” as contemplated herein has been launched. The source file may be a saved file or created after launching the software program. The source file may include at least one security feature and may be a black and white image file or a multi-tonal file. The parameters such as the resolution of the output device, the corresponding tiles (or functions) for the background areas and security feature areas may be elected by the user or otherwise determined at 232. The conversion process may be initiated at 234 such that the image tones (or lack thereof) may be used to indicate background areas and security feature areas and a corresponding tile (or function) for each area, i.e., the background areas and security feature areas to produce a converted electronic digital file may then be generated from the source image including the security features and/or background areas. The converted electronic digital file may then be saved at 236 in a format suited for use as a stand-alone graphic image or may be incorporated into other programs ready for output onto a selected printing device. It may be appreciated that the above steps may occur in a number of orders and may not be limited to the order presented above.

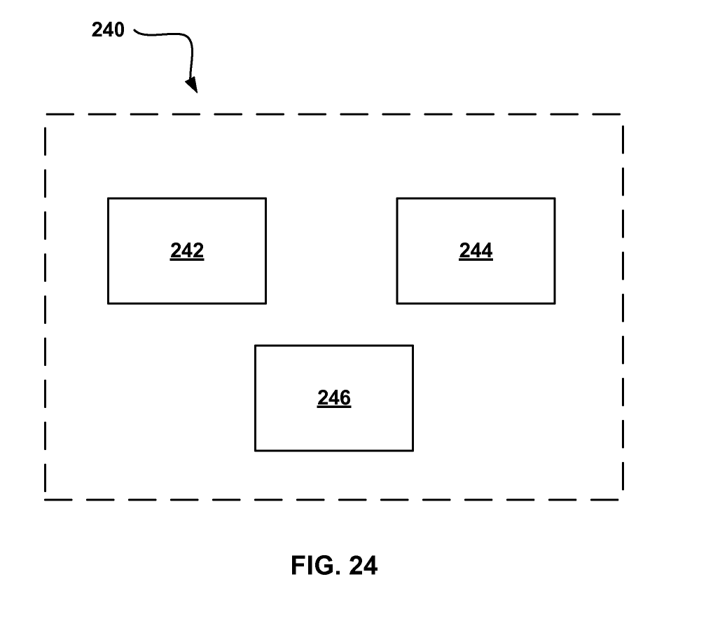

It may also be appreciated that the functionality or “plug-ins” described herein for the embodiments of the present invention may be implemented by using hardware, software, or a combination of hardware and software, either within a computer, printer or other printing device, as desired. If implemented by software, a processor and a machine readable medium may be required. The processor may be of any type of processor capable of providing the speed and functionality required by the embodiments of the invention. Machine-readable memory includes any media capable of storing instructions adapted to be executed by a processor. Some examples of such memory may include, but are not limited to, read-only memory (ROM), random-access memory (RAM), programmable ROM (PROM), erasable programmable ROM (EPROM), electronically erasable programmable ROM (EEPROM), dynamic RAM (DRAM), magnetic disk (e.g., floppy disk and hard drive), optical disk (e.g. CD-ROM), and any other device that can store digital information. The instructions may be stored on medium in either a compressed and/or encrypted format. Accordingly, in the broad context of the present invention, and with attention to FIG. 24, the computer, printer or other printing device 240, as desired, may contain a processor 242 and machine readable media 244 and user interface 246.

While this invention has been described as having a preferred design, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

What is claimed is:

1. A method to produce electronic digital files with document security features to prevent duplication of documents, where the resulting printed documents with document security features would be unobvious to the unaided eye upon inspection, the method comprising:
a) selecting a source image previously designed, where a specified tone is used to indicate a background area and another specified tone(s) is/are used to indicate at least one security feature(s) area;
b) selecting one or more corresponding tiles and/or one or more corresponding functions for (i) the background area and (ii) the at least one security feature(s) area
c) generating a converted electronic digital file from the source image with the desired security feature(s); and
d) saving the converted electronic digital file in a format suited for use as a stand-alone graphic image or incorporated into other programs ready for output onto the output device.

2. The method of claim 1 wherein said source image takes the file format as a single 1 bit and/or a multi bit grayscale or color image file.

3. The method of claim 1 wherein said at least one security feature(s) is selected from the group consisting of large dot-small dot patterns, line screen patterns, dash line screen patterns, scramble indicia and combinations thereof.

4. The method of claim 1 wherein said one or more corresponding tiles are selected from memory.

5. The method of claim 1 wherein said one or more corresponding functions call on a sequence of native processes and functions residing in conventional graphics software programs.

6. The method of claim 1 wherein said converted electronic digital file is set at a fraction of the resolution of the output device.

7. The method of claim 1 further comprising selecting on-demand for output with or without other document content said converted electronic digital file using standard computing software selected from the group consisting of QUARK EXPRESS®, ADOBE IN-DESIGN®, ADOBE PAGEMAKER®, ADOBE ILLUSTRATOR®, COREL DRAW®, MICROSOFT OFFICE PUBLISHER®, MICROSOFT OFFICE®, SUN OPEN OFFICE®, COREL WORDPERFECT®, ADOBE ACROBAT® and combination thereof.

8. The method of claim 1 wherein said converted electronic digital file is save in a file format selected from the group consisting of BMP, RLE, GIF, EPS, JPEG, PCT, PNG, TIFF, EMF, WMF, RAW and combinations thereof.

9. The method of claim 1 wherein said output device is selected from the group consisting of film image setters, computer to plate setters to generate file or plate, offset printers, letterpresses, flexographic printers, intaglio printers, gravure printers, and combinations thereof.

10. The method of claim 1 wherein said output device is selected from the group consisting of commercial digital presses, ink jet digital printers, multifunction printers, toner based digital printers and combinations thereof.

11. The method of claim 1 wherein said converted electronic digital file resides in a client/server based printer driver or firmware of digital output equipment.

12. An article comprising a storage medium having stored thereon instruction that when executed by a machine result in the following operations:
a) selecting a source image previously designed, where a specified tone is used to indicate a background area and another specified tone(s) is/are used to indicate at least one security feature(s) area;
b) selecting one or more corresponding tiles and/or one or more corresponding functions for (i) the background area and (ii) the at least one security feature(s) area
c) generating a converted electronic digital file from the source image with the desired security feature(s); and
d) saving the converted electronic digital file in a format suited for use as a stand-alone graphic image or incorporated into other programs ready for output onto the output device.

13. The article of claim 12 wherein said source image takes the file format as a single 1 bit and/or a multi bit grayscale or color image file.

14. The article of claim 12 wherein said at least one security feature(s) is selected from the group consisting of large dot-small dot patterns, line screen patterns, dash line screen patterns, scramble indicia and combinations thereof.

15. The article of claim 12 wherein said one or more corresponding tiles are selected from memory.

16. The article of claim 12 wherein said one or more corresponding functions call on a sequence of native processes and functions residing in conventional graphics software programs.

17. The article of claim 12 wherein said converted electronic digital file is set at a fraction of the resolution of the output device.

18. The article of claim 12 wherein said instructions that when executed by said machine result in the following additional operations selecting on-demand for output with or without other document content said converted electronic digital file using standard computing software selected from the group consisting of QUARK EXPRESS®, ADOBE IN-DESIGN®, ADOBE PAGEMAKER®, ADOBE ILLUSTRATOR®, COREL DRAW®, MICROSOFT OFFICE PUBLISHER®, MICROSOFT OFFICE®, SUN OPEN OFFICE®, COREL WORDPERFECT®, ADOBE ACROBAT® and combination thereof.

19. The article of claim 12 wherein said converted electronic digital file is save in a file format selected from the group consisting of BMP, RLE, GIF, EPS, JPEG, PCT, PNG, TIFF, EMF, WMF, RAW and combinations thereof.

20. The article of claim 12 wherein said output device is selected from the group consisting of film image setters, computer to plate setters to generate file or plate, offset printers, letterpresses, flexographic printers, intaglio printers, gravure printers, and combinations thereof.

21. The article of claim 12 wherein said converted electronic digital file resides in a client/server based printer driver or firmware of digital output equipment.
